(19) United States
(12) Patent Application Publication
(10) Pub. No.: US 2016/0039377 A1
(43) Pub. Date: Feb. 11, 2016

(54) Event Data Recorder Capable of Detecting and Notifying a Vehicle Accident

(71) Applicant: Yi-Ou Hsu, Taoyuan City (TW)

(72) Inventor: Yi-Ou Hsu, Taoyuan City (TW)

(21) Appl. No.: 14/475,652

(22) Filed: Sep. 3, 2014

(30) Foreign Application Priority Data
Aug. 8, 2014 (TW) 103214118

(51) Int. Cl. B60R 21/00; G01V 7/04

(52) U.S. Cl. CPC B60R 21/00; G01V 7/04; B60R 2021/0027

(57) ABSTRACT

An event data recorder includes a three-axis gravity sensor unit and a communicating unit connected to an electronic product. When the three-axis gravity sensor unit detects a change in a speed and an angular position of the vehicle and sends out a detection signal indicative of the change, the event data recorder sends the detection signal to the electronic product by the communicating unit, and the electronic product transmits coordinate information corresponding to a coordinate position of the vehicle to a preset location. After the event data recorder sends the detection signal to the electronic product, the event data recorder fetches the status information stored before and after transmission of the detection signal, and the event data recorder transmits the status information to the electronic product. In another approach, the event data recorder obtains coordinate information by a coordinate unit.

### BACKGROUND OF THE INVENTION

The present invention relates to an event data recorder capable of detecting and notifying a vehicle accident and, more particularly, to an event data recorder capable of recording the driving status and automatically transmitting the driving status to an electronic product when a vehicle accident occurs.

More and more drivers install an event data recorder on their vehicles to protect their rights. An event data recorder can pick up images and record sounds around a vehicle any time during driving. When an accident occurs, the information stored in the event data recorder can be used to analyze the cause of the accident and find out who is responsible. However, ordinary event data recorders can only record the status information. If a serious traffic accident occurs and if the person involved is not able to ask help himself or herself, the situation might be helpless even if the event data recorder can subsequently be used to analyze the cause. In worst scenarios, the event data recorder is damaged and burned in the accident and, thus, cannot be used to analyze the cause.

### BRIEF SUMMARY OF THE INVENTION

The primary objective of the present invention is to provide an event data recorder for storing status information of a vehicle during driving. When a vehicle accident occurs, the event data recorder transmits coordinate information and status information of the vehicle accident to an electronic product. The electronic product, based on presetting, can ask help from the outside or store the coordinate information and the status information of the vehicle accident.

In a first aspect, the event data recorder includes a three-axis gravity sensor unit and a communicating unit connected to an electronic product. When the three-axis gravity sensor unit detects a change in a speed and an angular position of the vehicle and sends out a detection signal indicative of the change, the event data recorder sends the detection signal to the electronic product by the communicating unit, and the electronic product transmits coordinate information corresponding to a coordinate position of the vehicle to a preset location. After the event data recorder sends the detection signal to the electronic product, the event data recorder fetches the status information stored before and after transmission of the detection signal, and the event data recorder transmits the status information to the electronic product.

In a second aspect, an event data recorder includes a three-axis gravity sensor unit, a communicating unit connected to an electronic product, and a coordinate unit. When the three-axis gravity sensor unit detects a change in a speed and an angular position of the vehicle and sends out a detection signal indicative of the change, the event data recorder obtains coordinate information by the coordinate unit, the event data recorder transmits the coordinate information to the electronic product by the communicating unit, and the electronic product transmits the coordinate information of the vehicle to a preset location. After the event data recorder transmits the coordinate information to the electronic product, the event data recorder fetches the status information stored before and after transmission of the status information, and the event data recorder transmits the status information to the electronic product.

The preset location can be a storage device external to the electronic product or a rescue unit.

The electronic produce transmits the status information to the preset location after the electronic product receives the status information from the event data recorder.

After the electronic products transmits the status information to the preset location, the electronic product turns on sound to a maximum sound volume, makes an emergency call, and displays the coordinate position or plays an audio file.

The present invention will become clearer in light of the following detailed description of illustrative embodiments of this invention described in connection with the drawings.

### DESCRIPTION OF THE DRAWINGS

FIG. 1 is a block diagram of an event data recorder of a first embodiment according to the present invention.

FIG. 2 is a block diagram of an event data recorder of a second embodiment according to the present invention.

### DETAILED DESCRIPTION OF THE INVENTION

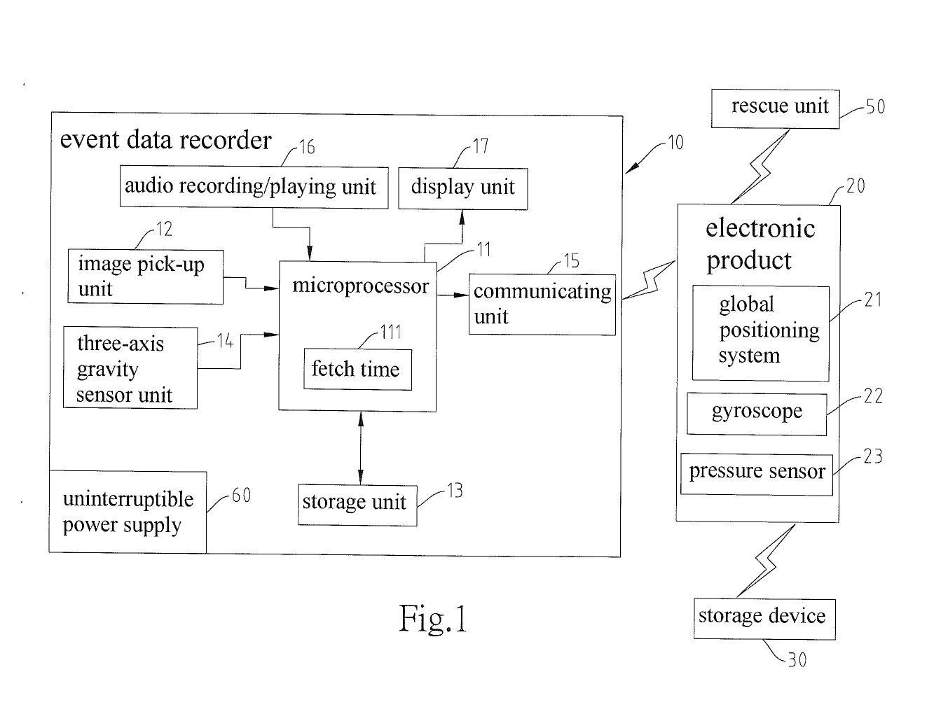

FIG. 1 shows an event data recorder 10 of a first embodiment according to the present invention. The event data recorder 10 is mounted to a vehicle and is connected to an uninterruptible power supply 60 that can supply power to the event data recorder 10 when the vehicle cannot provide power to the event data recorder 10. The event data recorder 10 includes a microprocessor 11 having a fetch time 111. The microprocessor 11 is connected to an image pick-up unit 12, a storage unit 13, a three-axis gravity sensor unit 14, a communicating unit 15, an audio recording/playing unit 16, and a display unit 17.

The image pick-up unit 12 is used to pick up images during driving. The audio recording/playing unit 16 is used to record and play sound. The images data picked up by the image pick-up unit 12 and the audio data recorded by the audio recording/playing unit 16 are stored in the storage unit 13. The display unit 17 is used to play the image data picked up by the image pick-up unit 12.

The three-axis gravity sensor unit 14 sends out a detection signal to the microprocessor 11 when the detected gravity drops to zero within a unit time or a change in a direction of the vehicle exceeds a preset angle.

The communicating unit 15 can be a bluetooth module or Wi-Fi module. The communicating unit 15 is wirelessly connected to an electronic product 20 including a global positioning system 21, a gyroscope 22, and a pressure sensor 23.

During the driving status of the vehicle, the storage unit 13 of the event data recorder 10 will store the image data of the image pick-up unit 12 and the audio data of the audio recording/playing unit 16 (namely, the status information of the vehicle during driving) in real time. In a case that a vehicle accident occurs, the speed of the vehicle rapidly decreases to zero, and the moving direction changes. Thus, the gravity detected by the three-axis gravity sensor unit 14 rapidly drops to zero, and the direction change detected by the three-axis gravity sensor unit 14 excesses the preset angle. In this case, the three-axis gravity sensor unit 14 sends out a detection signal to the microprocessor 11. After the detection signal is received by the microprocessor 11, the microprocessor 11 sends the detection signal to the electronic product 20 by the communicating unit 15 such that the electronic product 20 can obtain coordinate information of the electronic product 20 by the global positioning system 21. Then, the electronic product 20 transmits the coordinate information to a preset location. The preset location can be a storage device 30 and a rescue unit 50 both of which are external to the electronic product 20.

Furthermore, the microprocessor 11 fetches the image data and audio data (the status information) according to the fetch time 111, wherein the status information is stored in the storage unit 13 before and after transmission of the detection signal. Then, the event data recorder 10 transmits the status information to the electronic product 20 by the communicating unit 15. Next, the electronic product 20 transmits the status information to the storage device 30 and the rescue unit 50. The rescue unit 50 can be an emergency telephone number (“112” in European Community, “”911” in the United States and Canada, or “110” or “119” in China, Japan, and Taiwan). Furthermore, the telephone number of the family or a friend of a user of the electronic product 20 can be preset. Furthermore, the gyroscope 22 of the electronic product 20 is used to assist the global positioning system 21. In a case that the global positioning system 21 receives poor signals or cannot calculate the coordinate position, the gyroscope 22 can be used to measure the moving direction and the moving distance such that the electronic product 20 can obtain the coordinate position. The pressure sensor 23 is used to detect the atmosphere pressure to obtain the altitude above the sea level for assisting the global positioning system 21.

Furthermore, after the electronic products 20 transmits the status information (the image data and the audio data) to the preset location, the electronic product 20 turns on the sound to the maximum sound volume, makes an emergency call, and displays the coordinate position or plays an audio file. The audio file is pre-recorded in the electronic product 20 by the user.

Thus, a driver or passenger of the vehicle can preset the electronic product 20 (such as a smart phone, a personal digital assistant, etc.) to transmit the image data and the audio data to the storage device 30 (such as an email address, cloud equipment, communication software, or a text message address) external to the electronic product 20 after the electronic product 20 has received the detection signal, the image data, and the audio data from the event data recorder 10. Upon reception of the detection signal of the event data recorder 10 by the electronic product 20, the coordinate information of the electronic product 20 is transmitted to and stored in the storage device 30 in real time. Thus, other people can know the location of the vehicle accident and conduct a rescue operation while permitting analysis of the cause of the accident and finding out the responsibility even if the image data and the audio data are damaged. Furthermore, since the image data and the audio data are large files and, thus, require a longer period of time for transmission while the coordinate information can be transmitted in a very short period of time, the electronic product 20 obtains the coordinate information first and transmits it to the storage device 30 to assure recording of the accident location.

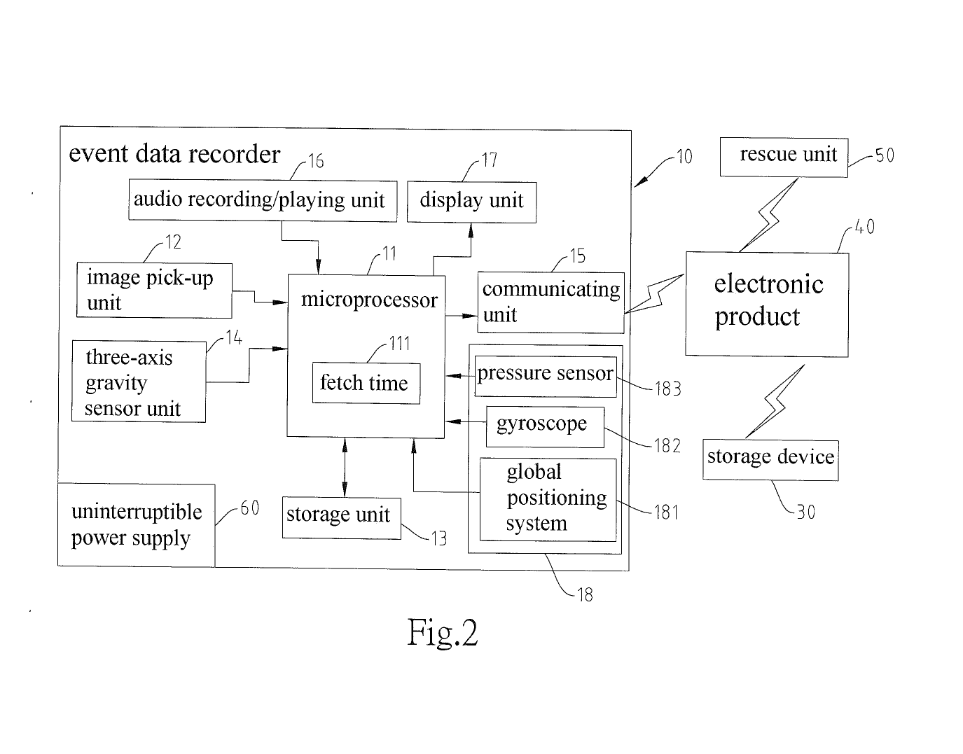

FIG. 2 shows an event data recorder 10 of a second embodiment according to the present invention. The second embodiment is different from the first embodiment by that the microprocessor 11 is further connected to a coordinate unit 18. The coordinate unit 18 includes a global positioning system 181, a gyroscope 182, and a pressure sensor 183. The global positioning system 181 is used to obtain the coordinate position of the event data recorder 10 and can transmit the coordinate position to the microprocessor 11 upon request by the microprocessor 11. The gyroscope 182 is used to assist the global positioning system 181. In a case that the global positioning system 181 receives poor signals or cannot calculate the coordinate position, the gyroscope 182 can be used to measure the moving direction and the moving distance such that the coordinate position can be obtained. The pressure sensor 183 is used to detect the atmosphere pressure to obtain the altitude above the sea level for assisting the global positioning system 181.

When the three-axis gravity sensor unit 14 sends out a detection signal to the microprocessor 1, the microprocessor 11 firstly obtain the coordinate information of the event data recorder 10 by the global positioning system 181 of the coordinate unit 18 after the detection signal is received by the microprocessor 11. After the coordinate information is transmitted by the communicating unit 15 to an electronic product 40, the electronic product 40 firstly transmit the coordinate information to the preset location which can be a storage device 30 and a rescue unit 50 both of which are external to the electronic product 40.

Furthermore, the microprocessor 11 fetches the status information (image information and audio information) according to the fetch time 111, wherein the status information are stored in the storage unit 13 before and after transmission of the detection signal. Then, the event data recorder 10 transmits the status information to the electronic product 40 by the communicating unit 15.

Thus, a driver or passenger of the vehicle can preset the electronic product 40 (such as a smart phone, a personal digital assistant, etc.) to transmit the image data and the audio data to the storage device 30 and the rescue unit 50 (such as an email address, cloud equipment, communication software, or a text message address) external to the electronic product 40 after the electronic product 40 has received the image data and the audio data from the event data recorder 10.

Upon reception of the coordinate information, the image data, and the audio data of the event data recorder 10 by the electronic product 40, the coordinate information is transmitted to the storage device 30 and the rescue unit 50 and is stored in the storage device 30 and the rescue unit 50 in real time. Thus, other people can know the location of the vehicle accident and conduct a rescue operation while permitting analysis of the cause of the accident and finding out the responsibility even if the image data and the audio data are damaged. Similarly, the microprocessor 11 will firstly transmit coordinate information to the electronic product 40 and then the image data and the audio data to assure recording of the accident location.

Although specific embodiments have been illustrated and described, numerous modifications and variations are still possible without departing from the scope of the invention. The scope of the invention is limited by the accompanying claims.

1. An event data recorder capable of detecting and notifying a vehicle accident, with the event data recorder adapted for storing status information of a vehicle during driving, with the event data recorder comprising a three-axis gravity sensor unit and a communicating unit connected to an electronic product,
wherein when the three-axis gravity sensor unit detects a change in a speed and an angular position of the vehicle and sends out a detection signal indicative of the change, the event data recorder sends the detection signal to the electronic product by the communicating unit, and the electronic product transmits coordinate information corresponding to a coordinate position of the vehicle to a preset location, and
wherein after the event data recorder sends the detection signal to the electronic product, the event data recorder fetches the status information stored before and after transmission of the detection signal, and the event data recorder transmits the status information to the electronic product.

2. The event data recorder as claimed in claim 1, wherein the preset location is a storage device external to the electronic product.

3. The event data recorder as claimed in claim 1, wherein the preset location is a rescue unit.

4. The event data recorder as claimed in claim 1, wherein the electronic produce transmits the status information to the preset location after the electronic product receives the status information from the event data recorder.

5. The event data recorder as claimed in claim 4, wherein the preset location is a storage device external to the electronic product.

6. The event data recorder as claimed in claim 4, wherein the preset location is a rescue unit.

7. The event data recorder as claimed in claim 4, wherein after the electronic products transmits the status information to the preset location, the electronic product turns on sound to a maximum sound volume, makes an emergency call, and displays the coordinate position.

8. The event data recorder as claimed in claim 4, wherein after the electronic products transmits the status information to the preset location, the electronic product turns on sound to a maximum sound volume, makes an emergency call, and plays an audio file.

9. An event data recorder capable of detecting and notifying a vehicle accident, with the event data recorder adapted for storing status information of a vehicle during driving, with the event data recorder comprising a three-axis gravity sensor unit, a communicating unit connected to an electronic product, and a coordinate unit,
wherein when the three-axis gravity sensor unit detects a change in a speed and an angular position of the vehicle and sends out a detection signal indicative of the change, the event data recorder obtains coordinate information by the coordinate unit, the event data recorder transmits the coordinate information to the electronic product by the communicating unit, and the electronic product transmits the coordinate information of the vehicle to a preset location, and
wherein after the event data recorder transmits the coordinate information to the electronic product, the event data recorder fetches the status information stored before and after transmission of the status information, and the event data recorder transmits the status information to the electronic product.

10. The event data recorder as claimed in claim 9, wherein the preset location is a storage device external to the electronic product.

11. The event data recorder as claimed in claim 9, wherein the preset location is a rescue unit.

12. The event data recorder as claimed in claim 9, wherein the electronic produce transmits the status information to the preset location after the electronic product receives the status information from the event data recorder.

13. The event data recorder as claimed in claim 12, wherein the preset location is a storage device external to the electronic product.

14. The event data recorder as claimed in claim 12, wherein the preset location is a rescue unit.

15. The event data recorder as claimed in claim 12, wherein after the electronic products transmits the status information to the preset location, the electronic product turns on sound to a maximum sound volume, makes an emergency call, and displays the coordinate position.

16. The event data recorder as claimed in claim 12, wherein after the electronic products transmits the status information to the preset location, the electronic product turns on sound to a maximum sound volume, makes an emergency call, and plays an audio file.
